(19) United States
(12) Patent Application Publication
(10) Pub. No.: US 2010/0077482 A1
(43) Pub. Date: Mar. 25, 2010

(54) METHOD AND SYSTEM FOR SCANNING ELECTRONIC DATA FOR PREDETERMINED DATA PATTERNS

(76) Inventor: Robert Edward Adams, Mountain View, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/236,421

(22) Filed: Sep. 23, 2008

(51) Int. Cl. G06F 21/00

(52) U.S. Cl. 726/24

(57) ABSTRACT

A method and system for scanning electronic data for predetermined data patterns is described. One embodiment reads the electronic data serially; consults, during the reading, an acceleration list, the acceleration list specifying one or more sections of the electronic data that are to be scanned for the predetermined data patterns, at least one predetermined data pattern being applicable to each of the one or more sections based, at least in part, on a predetermined data address range associated with the at least one predetermined data pattern lying within that section of the electronic data, the predetermined address range specifying a location of a potential occurrence, within the electronic data, of the at least one predetermined data pattern; scans for predetermined data patterns, during the reading, only the one or more sections of the electronic data specified in the acceleration list; and reports results of the scanning to a user.

### FIELD OF THE INVENTION

The present invention relates generally to digital computers. In particular, but not by way of limitation, the present invention relates to methods and systems for scanning electronic data for predetermined data patterns.

### BACKGROUND OF THE INVENTION

In some computer applications, the need arises to scan streaming data for the presence of predetermined data patterns of interest as the data is being read. This need can arise, for example, in the context of a network gateway apparatus that receives streaming data over a network or in the context of a digital computer that reads, in serial (streaming) fashion, a file residing on a computer storage device.

Though the specific predetermined data patterns to be detected can vary widely, depending on the particular application, one example of such predetermined data patterns is malware definitions or signatures used to identify malware in electronic data. Such malware can include, without limitation, viruses, Trojan horses, worms, spyware, adware, keyloggers, or other types of malware.

Conventional approaches to scanning streaming data for predetermined data patterns are often slow and inefficient, adding considerable latency to the transport of streaming data.

It is thus apparent that there is a need in the art for an improved method and system for scanning electronic data for predetermined data patterns.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for scanning electronic data for predetermined data patterns. One illustrative embodiment is a method for scanning electronic data for predetermined data patterns, the method comprising reading the electronic data in serial fashion; consulting, during the reading, an acceleration list, the acceleration list specifying one or more sections of the electronic data that are to be scanned for the predetermined data patterns, at least one predetermined data pattern being applicable to each of the one or more sections based, at least in part, on a predetermined data address range associated with the at least one predetermined data pattern lying within that section of the electronic data, the predetermined address range specifying a location of a potential occurrence, within the electronic data, of the at least one predetermined data pattern; scanning for predetermined data patterns, during the reading, only the one or more sections of the electronic data specified in the acceleration list; and reporting results of the scanning to a user.

Another illustrative embodiment is a method for scanning electronic data for malware, the method comprising reading the electronic data in serial fashion; and performing the following as the electronic data is being read in serial fashion: consulting an acceleration list, the acceleration list specifying one or more sections of the electronic data that are to be scanned for malware, at least one malware definition being applicable to each of the one or more sections based, at least in part, on a predetermined data address range associated with the at least one malware definition lying within that section of the electronic data, the predetermined address range specifying a location of a potential occurrence, within the electronic data, of the at least one malware definition; scanning for malware only the one or more sections of the electronic data specified in the acceleration list; and taking corrective action responsive to results of the scanning.

Another illustrative embodiment is a computer system, comprising at least one processor; a storage device containing electronic data organized as one or more files; and a memory containing a plurality of program instructions executable by the at least one processor, the plurality of program instructions being configured to cause the at least one processor, while reading a particular file in serial fashion, to: consult an acceleration list, the acceleration list specifying one or more sections of the particular file that are to be scanned for malware, at least one malware definition being applicable to each of the one or more sections based, at least in part, on a predetermined data address range associated with the at least one malware definition lying within that section of the particular file, the predetermined address range specifying a location of a potential occurrence, within the particular file, of the at least one malware definition; scan for malware only the one or more sections of the particular file specified in the acceleration list; and take corrective action responsive to results of scanning for malware only the one or more sections of the particular file specified in the acceleration list.

Yet another illustrative embodiment is a network gateway apparatus, comprising at least one processor; a communication interface configured to send and receive data over a network; and a memory containing a plurality of program instructions executable by the at least one processor, the plurality of program instructions being configured to cause the at least one processor, while reading a data stream from the network via the communication interface, to: consult an acceleration list, the acceleration list specifying one or more sections of the data stream that are to be scanned for malware, at least one malware definition being applicable to each of the one or more sections based, at least in part, on a predetermined data address range associated with the at least one malware definition lying within that section of the data stream, the predetermined address range specifying a location of a potential occurrence, within the data stream, of the at least one malware definition; scan for malware only the one or more sections of the data stream specified in the acceleration list; and take corrective action responsive to results of scanning for malware only the one or more sections of the data stream specified in the acceleration list.

The methods of the invention can also be embodied, at least in part, in a plurality of program instructions executable by a processor that are stored on a computer-readable storage medium.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a flowchart of a method for scanning electronic data for predetermined data patterns in accordance with an illustrative embodiment of the invention;

FIG. 2 is a functional block diagram of a computer system in accordance with an illustrative embodiment of the invention;

FIG. 3 is a high-level block diagram of an environment in which various illustrative embodiments of the invention can be implemented;

FIG. 4 is a functional block diagram of a Web proxy server in accordance with an illustrative embodiment of the invention;

FIG. 5 is a functional block diagram of a router in accordance with an illustrative embodiment of the invention;

FIG. 6 is a diagram of an acceleration list in accordance with an illustrative embodiment of the invention;

FIG. 7 is a diagram of an acceleration list in accordance with another illustrative embodiment of the invention;

FIG. 8 is a flow diagram of a method for scanning electronic data for malware in accordance with an illustrative embodiment of the invention;

FIG. 9 is a flowchart of a method for scanning electronic data for malware in accordance with an illustrative embodiment of the invention;

FIG. 10 is a flowchart of a method for scanning a given section of a stream of electronic data for malware in accordance with an illustrative embodiment of the invention; and

FIG. 11 is a flowchart of a method for applying an acceleration list to the scanning of electronic data for predetermined data patterns in accordance with an illustrative embodiment of the invention.

### DETAILED DESCRIPTION

In some applications, the predetermined data patterns to be detected apply sparsely to the electronic data (e.g., a file) being scanned. For example, it might be known that a particular predetermined data pattern (e.g., a text string or a malware definition) will occur only within a certain section of a file. Such a relevant section of a file may be defined in terms of, for example, a range of byte offsets relative to the beginning of the file or some other suitable reference point. It is, of course, unnecessary to scan portions of a data stream to which no predetermined data patterns are applicable (i.e., within which no predetermined data pattern is expected to occur). This property can be exploited to make the scanning of streaming data for predetermined data patterns faster and more efficient.

In various illustrative embodiments of the invention, a data structure called an “acceleration list” is used to speed up and render more efficient the scanning of streaming data for predetermined data patterns. An acceleration list identifies the specific portions of a data stream that are to be scanned for the presence of the predetermined data patterns. The information provided by such an acceleration list permits a streaming scanning algorithm to skip (not scan) portions of a data stream that do not need to be scanned for the predetermined data patterns, thereby improving the efficiency and speed of scanning.

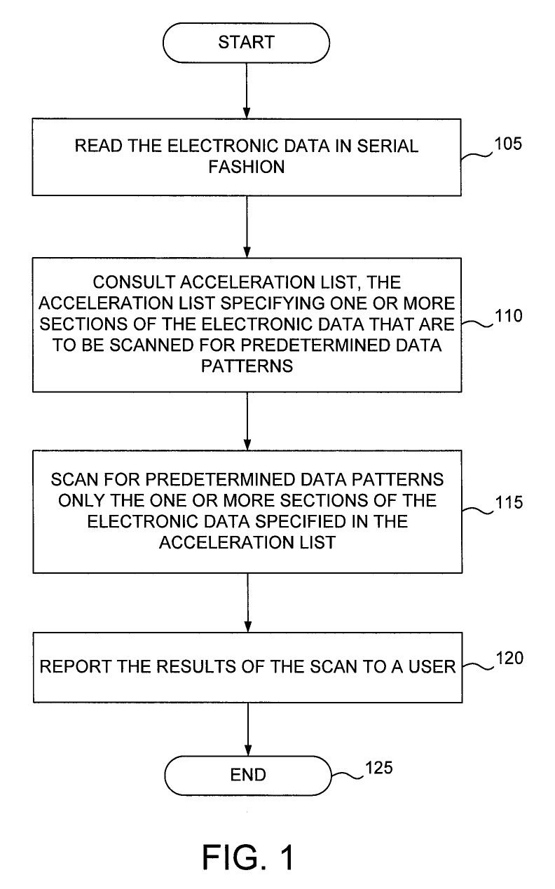

Referring now to the drawings, where like or similar elements are designated with identical reference numerals throughout the several views, and referring in particular to FIG. 1, it is a flowchart of a method for scanning electronic data for predetermined data patterns in accordance with an illustrative embodiment of the invention. At 105, electronic data (e.g., a file) is read in serial fashion (i.e., as a data stream). As the electronic data is being read in serial fashion, the actions in Blocks 110 and 115 are carried out. The action in Block 120 (reporting results to a user) can be performed while the electronic data is being read in serial fashion or after reading of the electronic data in serial fashion has been completed, depending on the particular embodiment.

At 110, an acceleration list is consulted. The acceleration list specifies one or more sections of the electronic data that are to be scanned for one or more predetermined data patterns. The sections of the electronic data specified in the acceleration list are those to which at least one predetermined data pattern is applicable. In one embodiment, a predetermined data pattern is considered to be “applicable” to a particular section of the electronic data if a predetermined data address range associated with the predetermined data pattern lies within that particular section. In such an embodiment, the predetermined data address range (e.g., a range of byte offsets relative to the beginning or other reference point of the file) associated with the predetermined data pattern specifies a location where the predetermined data pattern could occur within the electronic data.

At 115, only the sections of the electronic data specified in the acceleration list are scanned for the predetermined data patterns. Since none of the predetermined data patterns is applicable to the portions of the electronic data not specified in the acceleration list, there is no need to scan those portions of the electronic data.

At 120, the results of scanning the electronic data are reported to a user. For example, which predetermined data patterns were found in the electronic data can be reported to a user on a display, in a log file, or via e-mail. At 125, the method terminates.

Methods such as that discussed in connection with FIG. 1 have broad applicability where the amount of state information that needs to be stored is a small fraction of the data previously examined, and there is no need to jump backward or forward in the data stream. For example, the principles and techniques of the invention can be applied to the problem of detecting malware in streaming data, whether the streaming data is a file read from a computer storage device or a file received at a gateway apparatus over a network. Descriptions of some illustrative embodiments involving malware detection follow.

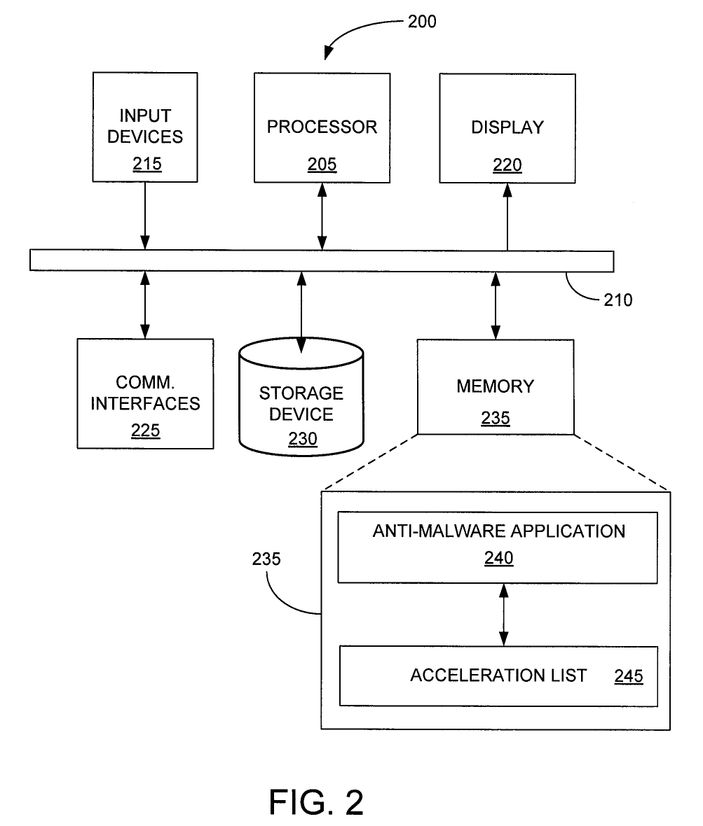

FIG. 2 is a functional block diagram of a computer system 200 in accordance with an illustrative embodiment of the invention. In FIG. 2, processor 205 communicates over data bus 210 with input devices 215, display 220, communication interfaces 225, storage device 230, and memory 235. Though FIG. 2 shows only a single processor, multiple processors or a multi-core processor may be present in some embodiments.

Input devices 215 include, for example, a keyboard, a mouse or other pointing device, or other devices that are used to input data or commands to computer system 200 to control its operation. Communication interfaces (“COMM. INTERFACES” in FIG. 2) 225 may include, for example, various serial or parallel interfaces for communicating with a network or one or more peripherals.

Memory 235 may include, without limitation, random access memory (RAM), read-only memory (ROM), flash memory, magnetic storage (e.g., a hard disk drive), optical storage, or a combination of these, depending on the particular embodiment. In FIG. 2, memory 235 includes anti-malware application 240, which maintains and makes use of acceleration list 245.

In one illustrative embodiment, anti-malware application 240 is implemented as software that is executed by processor 205. Such software may be stored, prior to its being loaded into RAM for execution by processor 205, on any suitable computer-readable storage medium such as a hard disk drive, an optical disk, or a flash memory (see, e.g., storage device 230). In general, the functionality of anti-malware application 240 may be implemented as software, firmware, hardware, or any combination or sub-combination thereof.

In the illustrative embodiment shown in FIG. 2, storage device 230 contains electronic data organized as one or more files. In this embodiment, anti-malware application 240 is capable of reading files from storage device 230 in serial fashion and scanning them for malware definitions. That is, anti-malware application 240 determines whether any of a set of predetermined malware definitions (or signatures) are present in a file, the presence of one or more malware definitions indicating that the file is or includes malware. In one embodiment, the files scanned for malware include MICROSOFT WINDOWS Portable Executable (PE) files. In other embodiments, other file types can be scanned.

In scanning a file for malware, anti-malware application 240 consults acceleration list 245 and scans for malware only those sections of the file that are specified in the acceleration list, thereby speeding up the scan for malware and rendering it more efficient. The sections specified in the acceleration list are those to which at least one malware definition applies. Portions of a file to which no malware definitions apply need not be scanned for malware. Acceleration list 245 enables those portions of the file to be skipped by anti-malware application 240, freeing up the resources of computer system 200 for other purposes.

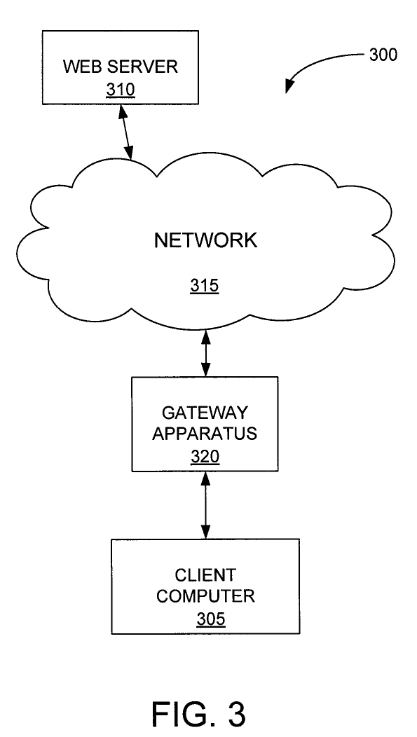

FIG. 3 is a high-level block diagram of an environment 300 in which various illustrative embodiments of the invention can be implemented. In FIG. 3, environment 300 includes a client computer 305 that communicates with Web server 310 over network 315 via gateway apparatus 320. As used herein, a “gateway apparatus” refers to any device that acts as an intermediary between a client computer and a server over a network. Examples include, without limitation, a Web proxy server, a router, and a firewall appliance. A gateway apparatus 320 is another suitable environment to which the principles of the invention can be applied.

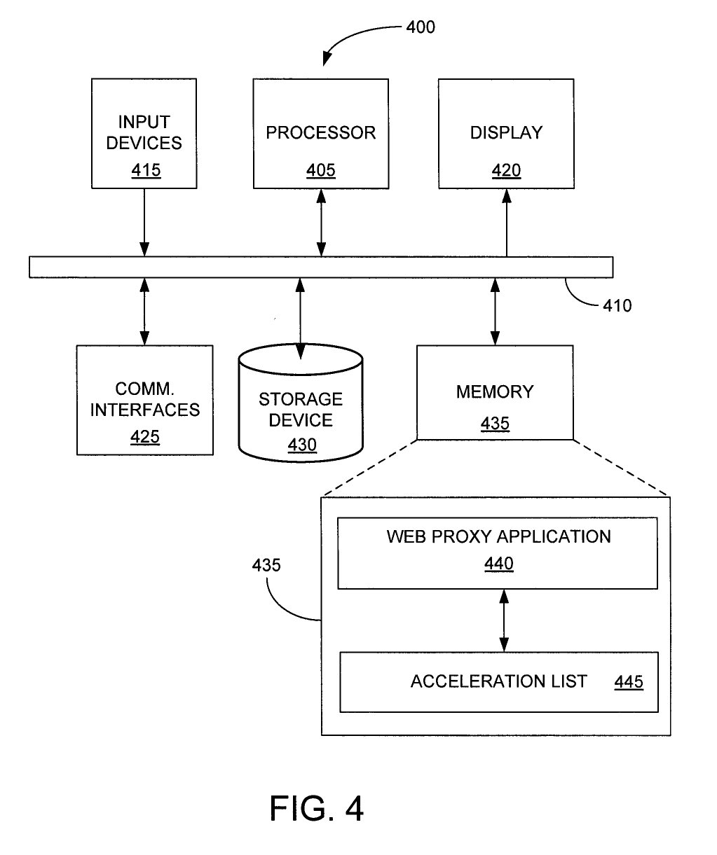

FIG. 4 is a functional block diagram of one type of gateway apparatus 320—a Web proxy server 400—in accordance with an illustrative embodiment of the invention. As those skilled in the computer-networking art are aware, a Web proxy server is a gateway apparatus that services the requests of client computers by forwarding those requests to other servers on a network. In FIG. 4, processor 405 communicates over data bus 410 with input devices 415, display 420, communication interfaces 425, storage device 430, and memory 435. Though FIG. 4 shows only a single processor, multiple processors or a multi-core processor may be present in some embodiments.

Input devices 415 include, for example, a keyboard, a mouse or other pointing device, or other devices that are used to input data or commands to Web proxy server 400 to control its operation.

In the illustrative embodiment shown in FIG. 4, communication interfaces 425 are provided, at least in part, by a Network Interface Card (NIC) that implements a standard such as IEEE 802.3 (often referred to as “Ethernet”) or IEEE 802.11 (a set of wireless standards). In general, communication interfaces 425 permit Web proxy server 400 to communicate with other computers such as client computer 305 and Web server 310 via one or more networks such as network 315 (see FIG. 3).

Memory 435 may include, without limitation, random access memory (RAM), read-only memory (ROM), flash memory, magnetic storage (e.g., a hard disk drive), optical storage, or a combination of these, depending on the particular embodiment. In FIG. 4, memory 435 includes Web proxy application 440, which includes an anti-malware engine (not shown in FIG. 4) that uses and maintains a set of malware definitions (not shown in FIG. 4).

A malware definition is a data pattern (e.g., a series of program instructions or a character string) and associated information (e.g., offset location within a file, hash value) characteristic of a particular type of malware that can be used to identify that type of malware in a file. As those skilled in the art are aware, malware definitions are often hashed so that hashed target data in a file to be scanned for malware can be compared with a hash value associated with the malware definition.

The anti-malware engine within Web proxy application 440 also maintains and makes use of acceleration list 445 in a manner similar to that described above in connection with anti-malware application 240 in FIG. 2. That is, the anti-malware engine scans, for malware, files (e.g., WINDOWS PE files) received as streaming data over network 315 and, in doing so, consults acceleration list 445 to speed up the process.

In one illustrative embodiment, Web proxy application 440 and its functional modules such as the anti-malware engine mentioned above are implemented as software that is executed by processor 405. Such software may be stored, prior to its being loaded into RAM for execution by processor 405, on any suitable computer-readable storage medium such as a hard disk drive, an optical disk, or a flash memory (see, e.g., storage device 430). In general, the functionality of Web proxy application 440 may be implemented as software, firmware, hardware, or any combination or sub-combination thereof.

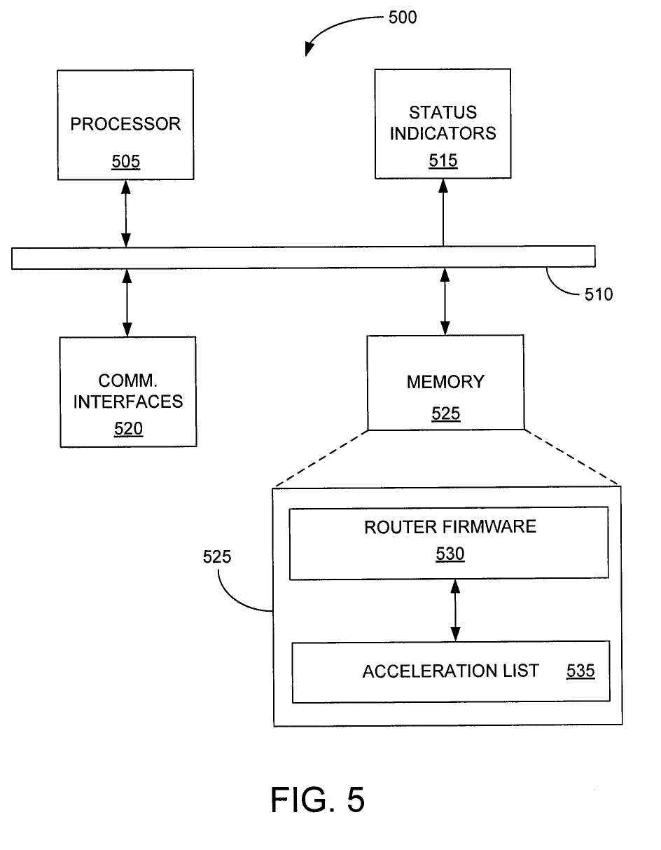

FIG. 5 is a functional block diagram of another type of gateway apparatus 320—a router 500—in accordance with an illustrative embodiment of the invention. In FIG. 5, processor 505 communicates over data bus 510 with status indicators 515, communication interfaces 520, and memory 525. As with the embodiment discussed in connection with FIGS. 2 and 4, more than one processor or a multi-core processor may be present in some embodiments. In one embodiment, status indicators 515 are light-emitting diodes (LEDs) or other visual indicators of the operational status of router 500. Communication interfaces 520 are similar to communication interfaces 425 described above in connection with FIG. 4.

In the illustrative embodiment shown in FIG. 5, memory 525 includes router firmware 530. In this embodiment, router firmware 530 includes an anti-malware engine (not shown in FIG. 5), which uses and maintains a set of malware definitions (not shown in FIG. 5). The anti-malware engine within router firmware 530 also maintains and makes use of acceleration list 535 in a manner similar to that described above in connection with anti-malware application 240 in FIG. 2. That is, the anti-malware engine scans, for malware, files (e.g., WINDOWS PE files) received as streaming data over network 315 and, in doing so, consults acceleration list 535 to speed up the process.

A network gateway apparatus such as Web proxy server 400 or router 500 may, in some embodiments, be configured as a network firewall. In the computer industry, a “firewall” commonly refers to a device, set of devices, and/or software/firmware configured to permit or deny, encrypt, decrypt, or proxy all network traffic between different security domains in accordance with a set of rules or other criteria.

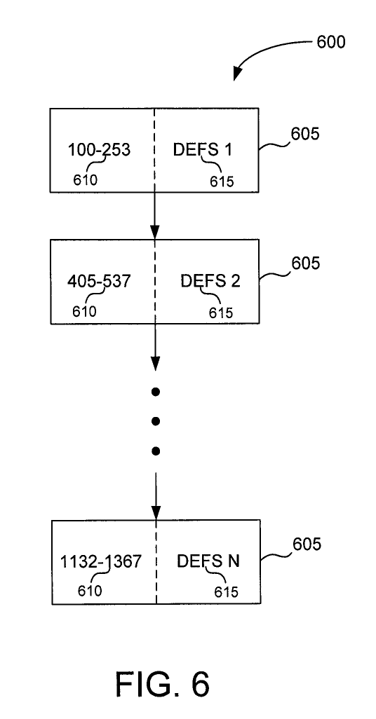

FIG. 6 is a diagram of an acceleration list 600 in accordance with an illustrative embodiment of the invention. In this particular embodiment, acceleration list 600 is implemented as a linked-list data structure made up of one or more elements 605. Each element 605 includes a data address range 610 that delimits a particular section of a data stream that is to be scanned for malware. That is, each element 605 corresponds to a section of the data stream to which at least one malware definition is applicable.

Each malware definition has an associated data address range (not shown in FIG. 6) within which a known data pattern (e.g., a series of program instructions or a character string) can potentially appear within a file. A given malware definition is considered to be applicable to a section if its associated data address range lies within the data address range 610 delimiting that section.

In this embodiment, each element 605 also includes an indication 615 of which specific malware definitions are applicable to the data address range 610 of the section to which that element 605 corresponds. In FIG. 6, the indicators 615 are labeled “DEFS 1,” “DEFS 2,” and “DEFS N,” for the first, second, and Nth sections, respectively. For example, the indicators 615 could be pointers to another data structure containing the actual malware definitions.

The particular data address ranges 610 shown in FIG. 6 are merely illustrative. Also, the elements 605 have been simplified somewhat in FIG. 6. For example, each element 605 also includes a pointer (not shown in FIG. 6) to the next element in the acceleration list 600.

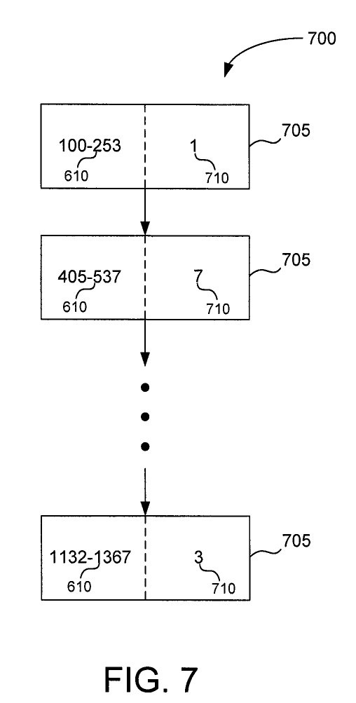

FIG. 7 is a diagram of an acceleration list 700 in accordance with another illustrative embodiment of the invention. In this embodiment, acceleration list 700 is again implemented as a linked-list data structure made up of elements 705. Each element includes a data address range 610 that delimits a particular section of a data stream that is to be scanned for malware, as in the embodiment discussed above in connection with FIG. 6. Instead of the indication 615, however, each element 705 includes a reference count 710. The reference count 710 is the number of malware definitions that are applicable to the data address range 610 of the section to which that element 705 corresponds. In this embodiment, the reference count for a given element 705 will always be at least 1 (i.e., there is at least one applicable malware definition for each section specified by the acceleration list 700). Why the elements 705 do not include an explicit indication of which malware definitions apply to their respective sections will become apparent from the further description below.

An acceleration list such as acceleration list 700 can be created by first sorting all of the malware definitions according to their respective associated data address ranges to which they apply and walking through the sorted list, adding linked-list elements 705 to acceleration list 700 or expanding or contracting the data address ranges 610 and incrementing or decrementing the reference counts 710 of existing elements 705 in acceleration list 700 as needed. If the reference count 710 of an element 705 drops to zero, that element 705 can be removed entirely from acceleration list 700. Thus, acceleration list 700 can be updated and maintained periodically as malware definitions are added or modified.

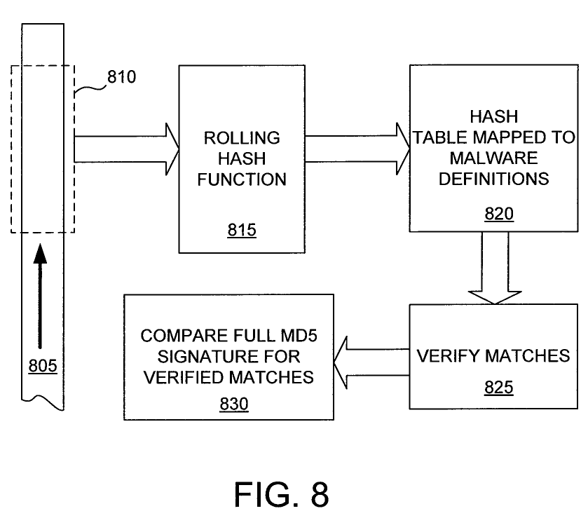

FIG. 8 is a flow diagram of a method for scanning electronic data for malware in accordance with an illustrative embodiment of the invention. FIG. 8 will be used to describe an efficiently-implemented embodiment of the invention that employs an acceleration list like that described above in connection with FIG. 7. In FIG. 8, a section 805 of a data stream specified in an element 705 of acceleration list 700 is scanned for malware as it is read. The arrow in FIG. 8 indicates the direction of “movement,” in this conceptual diagram, of section 805 as it is read and scanned. Conceptually, section 805 passes through a data window 810 as the electronic data is read. That is, as each new byte of section 805 is read, the oldest byte in data window 810 exits data window 810, and the byte just read enters data window 810. Initially, data window 810 can be filled with the first length-of-data-window-810 bytes of section 805. In one illustrative embodiment, data window 810 is 128 bytes long.

By using an appropriate streaming scanning algorithm, it is possible to compare the electronic data in the section 805 with all of the malware definitions in a complete set of malware definitions at the same time as section 805 is read. In the embodiment of FIG. 8, at each byte offset in section 805, the data in data window 810 is fed to a rolling hash function 815, which produces a corresponding rolling hash value that is used to index a hash table 820 that is mapped to the complete set of malware definitions. The hash table 820 includes a plurality of entries, each entry corresponding to a particular malware definition in the complete set of malware definitions. Examples of suitable streaming scanning algorithms include, without limitation, a multi-string version of the Rabin-Karp string search algorithm and the Aho-Corasick string search algorithm.

Those skilled in the computer-science art will recognize that an algorithm such as that just described is O(1). That is, the algorithm features what may be termed “amortized constant-time look up,” per byte read, of the entries in the hash table, the time per byte read being approximately independent of the number of malware definitions in the complete collection of malware definitions. This property stems from the rolling hash being used as an index (address) into the hash table 820.

If the rolling hash value computed at a given byte offset does not point to an entry in the hash table, no match occurs for that byte offset. If, on the other hand, the rolling hash value (index) points to an entry in the hash table, a match is indicated between the portion of the section 805 from which the rolling hash was computed and the malware definition corresponding to that entry in hash table 820.

Because the matches that result from the efficient O(1) look up occur without regard to the location within the data stream at which they occur, each match that occurs is verified at Block 825 to ensure that the match in section 805 occurred within the data address range associated with the applicable malware definition. Such a match is herein termed a “verified match.” This verification process weeds out false positives.

For each verified match, a full MD5 hash is computed on a range of data in section 805 specified in the applicable malware definition. That full MD5 hash is then compared, at Block 830, with a signature (another MD5 hash) associated with the applicable malware definition. The MD5 hash mentioned above is merely one illustrative type of hash function that can be employed in implementing various embodiments of the invention and is not intended to limit the scope of the appended claims.

One example of how the efficient O(1) scanning algorithm discussed above can be implemented follows. For a given section 805 within the stream of electronic data (e.g., a WINDOWS PE file), first the rolling hash is computed for the first length-of-data-window-810 (e.g., 128) bytes of section 805. For each subsequent byte read, the following steps are carried out:
1. The rolling hash value is computed and used to index hash table 820. If there is a match, the applicable malware definition is checked to determine whether the match occurred within its associated data address range. If so, that malware definition is added to an active-definition list, and the MD5 hash value for that item in the active-definition list is initialized with the 127 bytes preceding the most recently read byte of section 805.
2. The rolling hash is “rolled” by one byte by removing the oldest byte from data window 810 and adding the current byte to data window 810.
3. For each item in the active-definition list, (a) the current byte is added to the MD5 signature and (b) the MD5 signature is finalized for each item in the active-definition list for which the end of the range of data specified in the applicable malware definition has been reached. If the full MD5 hash matches that of the applicable malware definition, a positive result (malware present) is returned.

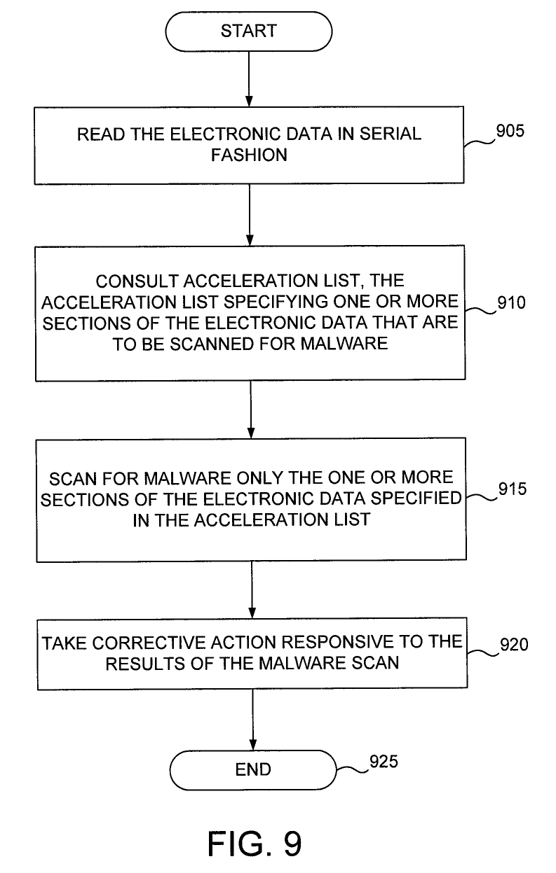

FIG. 9 is a flowchart of a method for scanning electronic data for malware in accordance with an illustrative embodiment of the invention. At 905, the computer system (e.g., 200) or gateway apparatus (e.g., 400 or 500) reads electronic data in serial fashion. The actions in Blocks 910, 915, and 920 are performed by anti-malware application 240 or an anti-malware engine associated with Web proxy application 440 or router firmware 530 while the electronic data is being read in serial fashion. In the following description, the “anti-malware function” refers to the anti-malware portion of an illustrative embodiment of the invention, whether that embodiment happens to be implemented in a computer system or in a gateway apparatus.

At 910, the anti-malware function consults an acceleration list, the acceleration list specifying one or more sections of the electronic data that are to be scanned for malware, at least one malware definition being applicable to each of those sections based, at least in part, on a predetermined data address range associated with each malware definition lying within that section of the electronic data. The predetermined data address range associated with each malware definition specifies a location of a potential occurrence, within the electronic data, of that malware definition, as explained above.

At 915, the anti-malware function scans for malware only those sections of the electronic data specified in the acceleration list. That is, the anti-malware function ignores the portions of the electronic data that are not specified in the acceleration list.

At 920, the anti-malware function takes appropriate corrective action responsive to the results of the scan at 915. That is, the anti-malware function takes corrective action if the scan at 915 reveals that the electronic data includes malware (viruses, Trojan horses, worms, spyware, adware, keyloggers, or other type of malware). The corrective action taken varies, depending on the particular embodiment. The following are some representative examples: (1) reporting the detected malware to a user, who could be a system administrator in some embodiments; (2) preventing the electronic data containing malware from propagating further over network 315 (i.e., blocking transport of the electronic data over the network); and (3) preventing the electronic data from executing (e.g., on a computer system such as computer system 200). In some embodiments, a combination of these actions can be performed to protect a local computer system or a client system on a network from becoming infected with malware. In the case of a local desktop computer system equipped with an anti-malware application, the anti-malware application can also be configured to remove the detected malware file from a storage device on which it resides.

At 925, the method terminates.

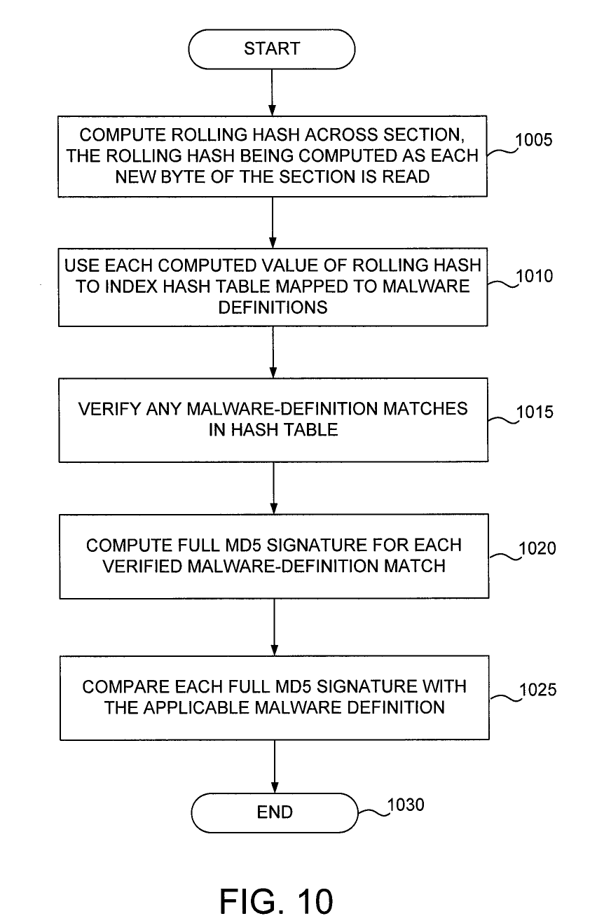

FIG. 10 is a flowchart of a method for scanning a given section of a stream of electronic data for malware in accordance with an illustrative embodiment of the invention. FIG. 10 summarizes some of the techniques and principles discussed above in connection with FIGS. 7 and 8.

At 1005, the anti-malware function computes a rolling hash across a section 805 of the electronic data in a data stream, as explained above in connection with FIG. 8. The rolling hash is computed as each new byte of section 805 is read.

At 1010, each computed value of the rolling hash is used as an index to a hash table 820, the hash table 820 including a plurality of entries, each entry in the plurality of entries corresponding to a particular malware definition in a complete set of malware definitions.

At 1015, it is determined, for each computed value of the rolling hash for which the index points to an entry in the hash table 820, whether the electronic data from which that value of the rolling hash was computed lies within the predetermined data address range associated with the particular malware definition that corresponds to that entry in the hash table 820. Thus, potential matches between the electronic data in the section 805 and the malware definitions are verified to ensure that each match occurred at a location within the section 805 consistent with the data-address-range specifications of the applicable malware definition.

At 1020, the anti-malware function computes, for each verified match, a full MD5 (or other suitable hash) signature for a region of electronic data in section 805 specified by the particular malware definition for which the verified match occurred.

At 1025, the anti-malware function compares the full MD5 signature associated with each verified match with the signature associated with the malware definition for which the verified match occurred. If the full signatures match, a positive result (malware detected in the electronic data) is returned.

At 1030, the method terminates.

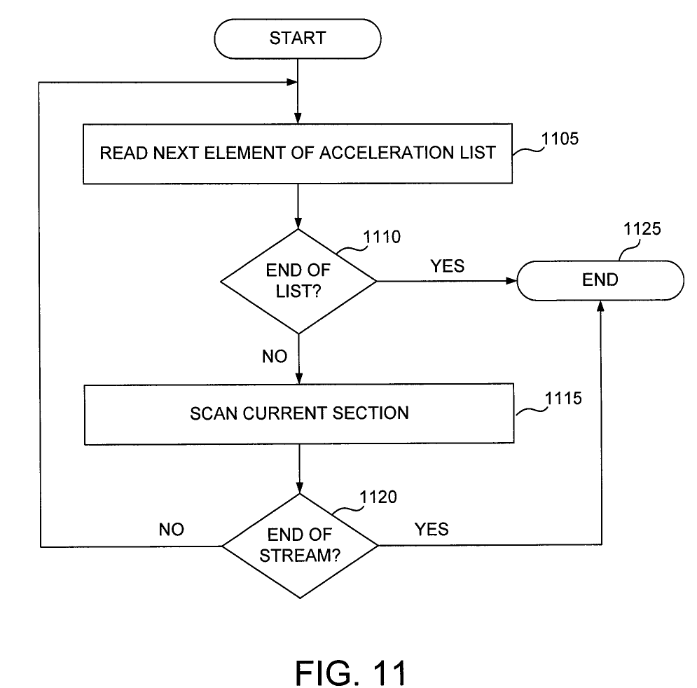

FIG. 11 is a flowchart of a method for applying an acceleration list to the scanning of electronic data for predetermined data patterns in accordance with an illustrative embodiment of the invention. FIG. 11 shows how, in an illustrative embodiment, an acceleration list can be applied to speed up the process of scanning a stream of data for predetermined data patterns. The method diagrammed in FIG. 11 is not confined to anti-malware applications but applies to scanning electronic data for any kind of predetermined data patterns (e.g., text strings).

At 1105, a scanning engine reads the next element of the acceleration list. If the end of the acceleration list had already been reached at 1110, the method terminates at 1125. Otherwise, the current section specified by the current element of the acceleration list is scanned for the predetermined data patterns at 1115. If the end of the data stream has been reached at 1120, the method terminates at 1125. Otherwise, the method returns to Block 1105.

In some applications, it is advantageous to employ multiple acceleration lists, either simultaneously or alternatively. In one such embodiment, each different acceleration list in a plurality of acceleration lists is associated with a different streaming scanning algorithm (e.g., Rabin-Karp or Aho-Corasick). Depending on the particular embodiment, the different scanning algorithms can be applied simultaneously in parallel or alternatively.

In another illustrative embodiment, each different acceleration list in a plurality of acceleration lists is associated with a different type of file (e.g., .exe, .gif, .jpg, .txt) that could potentially be scanned for predetermined data patterns. In such an embodiment, the header information of the serially-received file can be read to determine what kind of file is being read. The appropriate acceleration list for that kind of file can then be selected. In an anti-malware embodiment, the acceleration list selected for a particular file type is generated and maintained based on the particular malware definitions that are applicable to that file type.

In one illustrative embodiment of the invention, the methods of the invention are implemented, at least in part, as a plurality of program instructions executable by a processor and stored on a computer-readable storage medium such as, without limitation, a hard disk drive (HDD), optical disc, ROM, or flash memory. In such an embodiment, the plurality of program instructions may be divided into instruction segments (e.g., functions or subroutines).

In conclusion, the present invention provides, among other things, a method and system for scanning electronic data for predetermined data patterns. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims. For example, though the emphasis above has been on anti-malware embodiments, the principles of the invention are equally applicable to other pattern-detection applications such as finding text strings in electronic data.

What is claimed is:

1. A method for scanning electronic data for malware, the method comprising:
reading the electronic data in serial fashion; and
performing the following as the electronic data is being read in serial fashion:
consulting an acceleration list, the acceleration list specifying one or more sections of the electronic data that are to be scanned for malware, at least one malware definition being applicable to each of the one or more sections based, at least in part, on a predetermined data address range associated with the at least one malware definition lying within that section of the electronic data, the predetermined address range specifying a location of a potential occurrence, within the electronic data, of the at least one malware definition;
scanning for malware only the one or more sections of the electronic data specified in the acceleration list; and
taking corrective action responsive to results of the scanning.

2. The method of claim 1, wherein the electronic data is read from a file residing on a computer storage device.

3. The method of claim 1, wherein the electronic data is a file received as a data stream over a network.

4. The method of claim 1, wherein the acceleration list includes a linked list of elements, each element including a data address range delimiting a particular one of the one or more sections of the electronic data that are to be scanned for malware and a reference count indicating how many malware definitions are applicable to the particular one of the one or more sections of the electronic data that are to be scanned for malware.

5. The method of claim 4, wherein scanning for malware only the one or more sections of the electronic data specified in the acceleration list includes, for each section scanned:
computing a rolling hash across the section, the rolling hash being computed as each new byte of the section is read;
using each computed value of the rolling hash as an index to a hash table, the hash table including a plurality of entries, each entry in the plurality of entries corresponding to a particular malware definition in a set of malware definitions;
determining, for each computed value of the rolling hash for which the index points to an entry in the hash table, whether the electronic data from which that value of the rolling hash was computed lies within the predetermined data address range associated with the particular malware definition corresponding to that entry;
computing, for each particular malware definition for which the electronic data from which a value of the rolling hash was computed is determined to lie within the predetermined data address range associated with that particular malware definition, a full MD5 signature for a region of data associated with that particular malware definition; and
comparing each full MD5 signature with the particular malware definition associated with the region of data for which that full MD5 signature was computed.

6. The method of claim 1, wherein the acceleration list includes a linked list of elements, each element including a data address range delimiting a particular one of the one or more sections of the electronic data that are to be scanned for malware and an indication of which malware definitions among a set of malware definitions are applicable to the particular one of the one or more sections of the electronic data that are to be scanned for malware.

7. The method of claim 1, wherein the acceleration list is one of a plurality of acceleration lists, each acceleration list in the plurality of acceleration lists being associated with a different method for scanning the one or more sections of the electronic data that are to be scanned for malware.

8. The method of claim 1, wherein the acceleration list is one of a plurality of acceleration lists, each acceleration list in the plurality of acceleration lists being associated with a different type of file to which the electronic data can correspond, the acceleration list being selected in accordance with the type of file to which the electronic data corresponds.

9. The method of claim 1, wherein taking corrective action responsive to results of the scanning includes reporting to a user that the electronic data includes malware.

10. The method of claim 1, wherein taking corrective action responsive to results of the scanning includes preventing the electronic data from propagating further over a network when the scanning reveals that the electronic data includes malware.

11. A method for scanning electronic data for predetermined data patterns, the method comprising:
reading the electronic data in serial fashion;
consulting, during the reading, an acceleration list, the acceleration list specifying one or more sections of the electronic data that are to be scanned for the predetermined data patterns, at least one predetermined data pattern being applicable to each of the one or more sections based, at least in part, on a predetermined data address range associated with the at least one predetermined data pattern lying within that section of the electronic data, the predetermined address range specifying a location of a potential occurrence, within the electronic data, of the at least one predetermined data pattern;
scanning for predetermined data patterns, during the reading, only the one or more sections of the electronic data specified in the acceleration list; and
reporting results of the scanning to a user.

12. The method of claim 11, wherein the predetermined data patterns include malware definitions.

13. A computer system, comprising:
at least one processor;
a storage device containing electronic data organized as one or more files; and
a memory containing a plurality of program instructions executable by the at least one processor, the plurality of program instructions being configured to cause the at least one processor, while reading a particular file in serial fashion, to:
consult an acceleration list, the acceleration list specifying one or more sections of the particular file that are to be scanned for malware, at least one malware definition being applicable to each of the one or more sections based, at least in part, on a predetermined data address range associated with the at least one malware definition lying within that section of the particular file, the predetermined address range specifying a location of a potential occurrence, within the particular file, of the at least one malware definition;
scan for malware only the one or more sections of the particular file specified in the acceleration list; and
take corrective action responsive to results of scanning for malware only the one or more sections of the particular file specified in the acceleration list.

14. The computer system of claim 13, wherein the acceleration list includes a linked list of elements, each element including a data address range delimiting a particular one of the one or more sections of the particular file that are to be scanned for malware and a reference count indicating how many malware definitions are applicable to the particular one of the one or more sections of the particular file that are to be scanned for malware.

15. The computer system of claim 14, wherein, in scanning for malware only the one or more sections of the particular file specified in the acceleration list, the plurality of program instructions are configured to cause the at least one processor, for each section scanned, to:
compute a rolling hash across the section, the rolling hash being computed as each new byte of the section is read;
use each computed value of the rolling hash as an index to a hash table, the hash table including a plurality of entries, each entry in the plurality of entries corresponding to a particular malware definition in a set of malware definitions;
determine, for each computed value of the rolling hash for which the index points to an entry in the hash table, whether the electronic data from which that value of the rolling hash was computed lies within the predetermined data address range associated with the particular malware definition corresponding to that entry;
compute, for each particular malware definition for which the electronic data from which a value of the rolling hash was computed is determined to lie within the predetermined data address range associated with that particular malware definition, a full MD5 signature for a region of data associated with that particular malware definition; and
compare each full MD5 signature with the particular malware definition associated with the region of data for which that full MD5 signature was computed.

16. The computer system of claim 13, wherein the acceleration list includes a linked list of elements, each element including a data address range delimiting a particular one of the one or more sections of the particular file that are to be scanned for malware and an indication of which malware definitions among a set of malware definitions are applicable to the particular one of the one or more sections of the particular file that are to be scanned for malware.

17. A network gateway apparatus, comprising:
at least one processor;
a communication interface configured to send and receive data over a network; and
a memory containing a plurality of program instructions executable by the at least one processor, the plurality of program instructions being configured to cause the at least one processor, while reading a data stream from the network via the communication interface, to:
consult an acceleration list, the acceleration list specifying one or more sections of the data stream that are to be scanned for malware, at least one malware definition being applicable to each of the one or more sections based, at least in part, on a predetermined data address range associated with the at least one malware definition lying within that section of the data stream, the predetermined address range specifying a location of a potential occurrence, within the data stream, of the at least one malware definition;
scan for malware only the one or more sections of the data stream specified in the acceleration list; and
take corrective action responsive to results of scanning for malware only the one or more sections of the data stream specified in the acceleration list.

18. The network gateway apparatus of claim 17, wherein the acceleration list includes a linked list of elements, each element including a data address range delimiting a particular one of the one or more sections of the data stream that are to be scanned for malware and a reference count indicating how many malware definitions are applicable to the particular one of the one or more sections of the data stream that are to be scanned for malware.

19. The network gateway apparatus of claim 18, wherein, in scanning for malware only the one or more sections of the data stream specified in the acceleration list, the plurality of program instructions are configured to cause the at least one processor, for each section scanned, to:
compute a rolling hash across the section, the rolling hash being computed as each new byte of the section is read;
use each computed value of the rolling hash as an index to a hash table, the hash table including a plurality of entries, each entry in the plurality of entries corresponding to a particular malware definition in a set of malware definitions;
determine, for each computed value of the rolling hash for which the index points to an entry in the hash table, whether the data in the data stream from which that value of the rolling hash was computed lies within the predetermined data address range associated with the particular malware definition corresponding to that entry;
compute, for each particular malware definition for which the data in the data stream from which a value of the rolling hash was computed is determined to lie within the predetermined data address range associated with that particular malware definition, a full MD5 signature for a region of data in the data stream associated with that particular malware definition; and
compare each full MD5 signature with the particular malware definition associated with the region of data in the data stream for which that full MD5 signature was computed.

20. The network gateway apparatus of claim 17, wherein the acceleration list includes a linked list of elements, each element including a data address range delimiting a particular one of the one or more sections of the data stream that are to be scanned for malware and an indication of which malware definitions among a set of malware definitions are applicable to the particular one of the one or more sections of the data stream that are to be scanned for malware.

21. The network gateway apparatus of claim 17, wherein the network gateway apparatus is one of a Web proxy server and a router.

22. A computer-readable storage medium containing a plurality of program instructions executable by a processor for scanning electronic data for malware, the plurality of program instructions comprising:
a first instruction segment configured to read the electronic data in serial fashion; and
a second instruction segment configured to perform the following as the electronic data is being read in serial fashion:
consult an acceleration list, the acceleration list specifying one or more sections of the electronic data that are to be scanned for malware, at least one malware definition being applicable to each of the one or more sections based, at least in part, on a predetermined data address range associated with the at least one malware definition lying within that section of the electronic data, the predetermined address range specifying a location of a potential occurrence, within the electronic data, of the at least one malware definition;
scan for malware only the one or more sections of the electronic data specified in the acceleration list; and
a third instruction segment configured to take corrective action responsive to results of scanning for malware only the one or more sections of the electronic data specified in the acceleration list.

23. The computer-readable storage medium of claim 22, wherein the acceleration list includes a linked list of elements, each element including a data address range delimiting a particular one of the one or more sections of the electronic data that are to be scanned for malware and a reference count indicating how many malware definitions are applicable to the particular one of the one or more sections of the electronic data that are to be scanned for malware.

24. The computer-readable storage medium of claim 23, wherein, in scanning for malware only the one or more sections of the electronic data specified in the acceleration list, the second instruction is configured, for each section scanned, to:
compute a rolling hash across the section, the rolling hash being computed as each new byte of the section is read;
use each computed value of the rolling hash as an index to a hash table, the hash table including a plurality of entries, each entry in the plurality of entries corresponding to a particular malware definition in a set of malware definitions;
determine, for each computed value of the rolling hash for which the index points to an entry in the hash table, whether the electronic data from which that value of the rolling hash was computed lies within the predetermined data address range associated with the particular malware definition corresponding to that entry;
compute, for each particular malware definition for which the electronic data from which a value of the rolling hash was computed is determined to lie within the predetermined data address range associated with that particular malware definition, a full MD5 signature for a region of data associated with that particular malware definition; and
compare each full MD5 signature with the particular malware definition associated with the region of data for which that full MD5 signature was computed.

25. The computer-readable storage medium of claim 22, wherein the acceleration list includes a linked list of elements, each element including a data address range delimiting a particular one of the one or more sections of the electronic data that are to be scanned for malware and an indication of which malware definitions among a set of malware definitions are applicable to the particular one of the one or more sections of the electronic data that are to be scanned for malware.
